(19) United States
(12) Patent Application Publication
(10) Pub. No.: US 2021/0155795 A1
(43) Pub. Date: May 27, 2021

(54) ALIPHATIC COPOLYESTERS COMPOSITIONS WITH IMPROVED IMPACT AND WEATHER RESISTANCE

(71) Applicant: Eastman Chemical Company, Kingsport, TN (US)

(72) Inventor: Robert Erik Young, Kingsport, TN (US)

(73) Assignee: Eastman Chemical Company, Kingsport, TN (US)

(21) Appl. No.: 16/690,328

(22) Filed: Nov. 21, 2019

(51) Int. Cl. C08L 67/02; C08G 63/672; C08L 25/14; C08L 33/06; C08K 5/3492; C08K 5/18; C08K 5/13; C08K 5/524

(52) U.S. Cl. CPC C08L 67/025; C08G 63/672; C08L 25/14; C08L 33/062; C08L 2201/08; C08K 5/18; C08K 5/13; C08K 5/524; C08K 2201/014; C08K 5/3492

(57) ABSTRACT

Disclosed are polymeric compositions that exhibit improved weathering and ultraviolet radiation resistance. The compositions comprise a polymer, at least one ultra-violet light (UV) absorber, at least one primary antioxidant, at least one secondary antioxidant, at least one hindered amine light stabilizer and at least one chain extending agent. In some embodiments the invention comprises a polyester; at least one triazine UV absorber; at least one hindered phenol primary antioxidant; at least one phosphite secondary antioxidant; at least one hindered amine light stabilizer and at least one styrene-acrylate copolymer.

### FIELD OF THE INVENTION

The invention generally relates to the field of organic chemistry. More particularly this invention relates to polyesters and copolyesters having improved weathering characteristics and resistance to ultraviolet radiation.

### BACKGROUND OF THE INVENTION

Polyesters are commonly used to manufacture automotive parts such as dashboards, touch panels, arm rests and bumpers. Such automotive interior and exterior thermoplastic products need to be resistant to ultraviolet light (UV) induced radiation to prolong product life.

Condensation polymers containing aromatic rings, such as polyesters, can rapidly degrade when exposed to ultraviolet light (UV) and high humidity levels unless steps are taken to inhibit UV induced polyester degradation.

One solution to reduce UV induced polyester degradation is to add an UV-absorbing cap layer on top of the polyester to block UV impingement on the polyester surface. Such cap layers are suitable for sheet polyester products or flat articles wherein a cap layer is coextruded onto the polyester surface.

Bulk UV absorbers are often used to improve the weathering resistance and light stability of many classes of thermoplastic materials when exposed to sunlight and other ultraviolet light sources. The amounts of ultraviolet absorbers needed to protect polyesters are often extremely high and not economically feasible or result in undesirable color changes in the polyester material.

Thus a need exists for polyester compositions that are resistant to UV and humidity induced degradation.

The present invention addresses this need as well as others, which will become apparent from the following description and the appended claims.

### SUMMARY OF THE INVENTION

The invention is as set forth in the appended claims.

In one embodiment the invention is an ultraviolet light degradation resistant composition comprising:
a. a polymer;
b. at least one UV absorber;
c. at least one primary antioxidant;
d. at least one secondary antioxidant;
e. at least one hindered amine light stabilizer; and
f. at least one chain extending agent.

In another embodiment the invention is an ultraviolet light degradation resistant composition comprising:
a. a polyester;
b. at least one triazine UV absorber;
c. at least one hindered phenol primary antioxidant;
d. at least one phosphite secondary antioxidant;
e. at least one hindered amine light stabilizer; and
f. at least one styrene-acrylate copolymer.

In another embodiment the invention is an ultraviolet light degradation resistant composition comprising:
a. a polyester comprising the residues of:
   i. at least one of cyclohexane 1,4 dicarboxylic acid or dimethyl cyclohexane dicarboxylate; and
   ii. at least one of 1, 4 cyclohexanedimethanol or polytetramethylene ether glycol;
b. at least one triazine UV absorber;
c. at least one hindered phenol primary antioxidant;
d. at least one phosphite secondary antioxidant;
e. at least one hindered amine light stabilizer; and
f. at least one styrene-acrylate copolymer.

### DETAILED DESCRIPTION OF THE INVENTION

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein should be considered to be approximations (even when not qualified by the term “about”). These values and ranges may vary from their stated numbers depending upon the desired properties sought to be obtained by the present invention as well as the variations resulting from the standard deviation found in the measuring techniques. Moreover, the ranges described herein are intended and specifically contemplated to include all sub-ranges and values within the stated ranges. For example, a range of 0 to 100 is intended to describe and include all values within the range including sub-ranges such as 0.1-99.9, 60 to 90 and 70 to 80.

During exposure to ultraviolet light, many polymers undergo chain cleavage which results in the formation of free radical molecules and carboxylic acids which are highly reactive and will lead to autocatalytic degradation of the polymer. In addition, the free radicals can, in the presence of oxygen, react to create hydroxy, peroxy, peroxide, and mono and di-hydroxy terephthalates which are also very reactive and will lead to further polymer degradation.

UV absorbers are added to absorb UV radiation to inhibit polymer degradation. UV absorbers are supplied in multiple chemical families including benzotriazoles, benzophenones, triazines, benzoxazinones, oxanilides and benzylidene malonates. UV absorbers preferentially absorb UV radiation and thus protect the polymer from degradation. UV absorbers convert UV energy to heat and harmlessly dissipate it through the polymer matrix.

UV absorbers when used alone are limited in their effectiveness to inhibit polyester degradation because of physical limitations of the absorption process and the need for high concentrations of the absorber. UV absorbers are often quite yellow in appearance and the high loadings needed to achieve effective protection of the polymer often results in articles that are extremely discolored.

I have discovered that combinations of an ultraviolet absorber, a primary antioxidant, a secondary antioxidant, a hindered amine light stabilizer, and a chain extending additive unexpectedly can greatly reduce the color change due to exposure to ultraviolet light and humidity and can greatly improve the impact resistance od polymers, particularly of aliphatic copolyester ethers.

The present invention uses a combination of UV absorber, a primary antioxidant, a secondary antioxidant, a light stabilizer and a chain extending agent to inhibit UV induced polyester degradation.

Suitable UV absorbers for use in this invention include triazines, cyanoacrylates, benzotriazoles, naphthalenes, benzophenones, and benzoxazine-4-ones, or combinations thereof.

Primary antioxidants are added to react with free radicals thus inhibiting further degradation or reacting with oxygen to create hydroxy, peroxy, and other oxygen containing radicals. Hindered phenols and hindered amines are the main types of primary antioxidants used in thermoplastics.

Several characteristics must be considered in the choice of a hindered phenol including the relative phenol content, which affects its reactivity, and the molecular weight with higher being better to ensure that the antioxidant does not migrate easily out of the polymer. Similarly, the weight effectiveness, the compatibility and the basicity must be considered in the choice of a hindered amine. Suitable hindered phenols include phenolic antioxidant can be selected from hydroquinone, arylamine antioxidants such as 4,4′-bis(α,α-dimethylbenzyl)diphenylamine, hindered phenol antioxidants such as 2,6-di-tert-butyl-4-methylphenol, butylated p-phenyl-phenol and 2-(α-methylcyclohexyl)-4,6-dimethylphenol; bis-phenols such as 2,2′-methylenebis-(6-tert-butyl-4-methylphenol), 4,4′bis(2,6-di-tert-butylphenol), 4,4′-methylenebis(6-tert-butyl-2-methylphenol), 4,4′-butylene-bis(6-tert-butyl-3-methylphenol), methylenebis(2,6di-tertbutylphenol), 4,4′-thiobis(6-tert-butyl-2-methylphenol), and 2,2′-thiobis(4-methyl-6-tert-butylphenol); tris-phenols such as 1,3,5-tris(3,5-di-tert-butyl-4-hydroxyhydrocinnamoyl)-hexahydro-s-triazine, 1,3,5-trimethyl-2,4,6-tris(3,5-di-tert-butyl-4-hydroxybenzyl)benzene and tri(3,5-di-tert-butyl-4-hydroxyphenyl)phosphite; and pentaerythritol tetrakis[3-(3,5-di-t-butyl-4-hydroxyphenyl)propionate].

Phosphites are the most typically used secondary antioxidant used in thermoplastics. Secondary antioxidants react with hydroperoxides to produce non-radical products and are termed “hydroperoxide decomposers”. They differ from primary antioxidants in that they are decomposed by reaction with hydroperoxides into non-radical, non-reactive and thermally stable products. Secondary antioxidants prevent the split of hydroperoxides into extremely reactive alkoxy and hydroxy radicals. Typical secondary antioxidants are organophosphorus compounds, mostly phosphites or phosphonites. Molecular weight, reactivity and hydrolytic stability must all be considered in the choice of secondary antioxidant. Suitable phosphites or phosphonites include phosphite antioxidant is selected from at least one of tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; and combinations thereof.

Hindered amine light stabilizers (HALS) are efficient radical scavengers and are added to inhibit degradation of polymers that have already formed free radicals. The mechanism of how HALS work is not fully understood, but hydroperoxide decomposition and catalytically deactivating free radicals are thought to play a part in their effectiveness. Suitable hindered amine light stabilizers include 1,6-hexanediamine N, N-bis(2,2,6,6-tetramethyl-4-piperidinyl)(CAS #565450-39-7, known as Tinuvin Nor™371-FF, commercially available from BASF; or polymers with morpholine-2,4,6-trichloro1,3,5-triazine(CAS #193098-40-7); known as Cyasorb™ 3529 commercially available from Solvay or the like.

Chain extending additives include compounds such as bisanhydrides, bisoxaolines, and bisepoxides which react with —OH or —COOH end groups caused by hydrolytic degradation. Chain extending additives can also be added during melt processing to build molecular weight through ‘reactive extrusion’ or ‘reactive chain coupling’. Another effective type of chain extending additive are styrene-acrylate copolymers with epoxide functionalities. Suitable chain extending additives can include, but are not limited to, copolymers of glycidyl methacrylate with alkenes and acrylic esters, copolymers of glycidyl methacrylate with alkenes and vinyl acetate, and/or copolymers of glycidyl methacrylate and styrene. Suitable alkenes comprise ethylene, propylene, and mixtures of two or more of the foregoing. Suitable acrylic esters comprise alkyl acrylate monomers, including, but not limited to, methyl acrylate, ethyl acrylate, propyl acrylate, butyl acrylate, and combinations of the foregoing alkyl acrylate monomers. When present, the acrylic ester can be used in an amount of 15 weight % to 35 weight %, based on the total amount of monomer used in the copolymer, or in any other range described herein. When present, vinyl acetate can be used in an amount of 4 weight % to 10 weight % based on the total amount of monomer used in the copolymer.

In certain embodiments, the chain extender comprises acrylic esters comprising monomers selected from alkyl acrylate monomers, including, but not limited to, methyl acrylate, ethyl acrylate, propyl acrylate, butyl acrylate, and combinations thereof. In embodiments, the chain extender is a copolymer comprising at least one acrylic ester and styrene.

Illustrative examples of suitable chain extending agents comprise ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers.

Condensation polymers are also susceptible to hydrolytic degradation if not pre-dried or if they are held at elevated temperatures in moist air for a long period of time. Condensation polymers are any polymer where monomers form together to create a polymer and a by-product such as water or methanol is produced. The polymerization reaction is reversible; thus, condensation polymers must be pre-dried before processing.

Automotive applications are quite demanding as motor vehicles can be exposed for extended periods of time outdoors and exposed to conditions of UV radiation, high temperatures and high humidity. Thermoplastic materials use in interior and exterior applications must meet the fitness for use requirements of many Original Equipment Manufactures specifications. Third party organizations such as the Society of Automotive Engineers have specified accelerated testing methods for evaluating interior and exterior thermoplastic materials. Two of these methods are SAE J2527 and SAE J2412.

SAE J2527 is a performance-based standard for accelerated weathering that uses a Xenon Arc as a light source to simulate outdoor exposure to sunlight on an accelerated basis. This standard calls up practice ASTM G155 while specifying specific test and monitoring conditions. Testing to ASTM G155, using a proper filter combination, allows to reproduce the weathering effects occurring when materials are exposed to sunlight, heat and moisture on an accelerated basis. The exposure conditions required in SAE J2527 are identical to cycle #7 of ASTM G155.

SAE J2412 is a performance-based standard for accelerated weathering that uses a Xenon Arc as a light source to simulate indoor exposure to sunlight on an accelerated basis. This standard calls up practice ASTM G155 while specifying specific test and monitoring conditions. Testing to ASTM G155, using a proper filter combination, allows to reproduce the weathering effects occurring when materials are exposed to sunlight through window glass, heat and moisture. The exposure conditions required in SAE J2412 are identical to cycle #8 of ASTM G155.

The preferred embodiment of the present invention is to incorporate a UV absorber in the triazine family, but not limited to this class, at 0.1 to about 3 percent such as Cyasorb 1164 available from Solvay or Tinuvin 1600 or Tinuvin 1577 available from BASF, a primary antioxidant in the hindered phenol family, preferably Irganox 1010 commercially available from BASF, in the amounts of 0.01 to about 2.0% by weight, a secondary antioxidant in the phosphite family, preferably Irgafos 168 commercially available from BASF, in the amounts of 0.01 to 0.5% by weight, a hindered amine in the HALS and/or Nor-HALS family such a Cyasorb 3529 available from Solvay, and chain extending agent in the styrene-acrylate copolymer family, preferably Joncryl 4468 commercially available from BASF, in the amounts from 0.01 to 2.0% by weight into a polyester or copolyester.

The preferred polyester or copolyesters comprise compositions such as Ecdel 9966 a plasticizer free copolyester elastomer available commercially from Eastman Chemical Company, or copolyesters based on a combination of poly(cyclohexylene dimethylene cyclohexanedicarboxylate) with polytetramethylene ether glycol having a number average molecular weight of 1000 (PTMG 1000). Polyesters can be viewed as a combination of 100 mole % diacids and 100 mole % glycols. In this case the diacid used is cyclohexane 1,4 dicarboxylic acid (CHDA). In the manufacturing process CHDA or dimethyl cyclohexane dicarboxylate (DMCD) can be used depending on the process. The final polymer will have essentially the same properties. Branching agents such as trimellitic anhydride (TMA) can be used in the formula up to about 1 mole %. The glycols are a combination of cyclohexane dimethanol (CHDM) and polytetramethylene ether glycol having a number average molecular weight of about 1000 (PTMG 1000).

In some embodiments of this invention the polyester comprises the residues of:
i. 99 to 100 mole percent, based on the total molar acid content of the polyester, of a diacid selected from the group consisting of a cyclohexane dicarboxylic acid, a dimethylcyclohexane dicarboxylic acid, and combinations thereof;
ii. 75 to 92 mole percent of 1,4-cyclohexane dimethanol and 5 to 25 mole percent of polytetramethylene ether glycol based on the total glycol content of the polyester; and
iii. optionally up to 1 mole percent of a branching agent selected from the group consisting of glycerin, pentaerythritol, phenyl dianhydride, trimellitic anhydride and combinations thereof based on the total molar acid content of the polyester.

Blends of these UV absorbers, antioxidants, hindered amount light stabilizers and chain extenders and polyesters and copolyesters can be produced using typical plastics compounding and extrusion techniques or could be added during the polymerization process to produce pellets. These fully compounded or prepared pellets can be processed using convention polymer processing methods or concentrates of the above additives can be prepared and diluted with neat polyesters and copolyesters, to make sheet, film, injection molded articles, and blow molded articles, using conventional thermoplastic processing methods. To make powdered compositions, blends of these antioxidants, chain extender and polyesters and copolyesters must either be prepared directly during the polymerization process or compounded to produce pellets using typical plastics compounding and extrusion techniques. To make powders that are useful for 3D printing applications or powder coating of metals, the compounded pellets must be subsequently ground and reduced in size at cryogenic temperatures.

Other condensation polymers include liquid crystalline polyesters/amides/imides, polyesteramides, polyimides, polyetherimides, polyurethanes, polyureas, polybenzimidazole, polybenzoxazoles, polyimines, polycarbonate, and polyamides. Polycaprolactone, polycaprolactam, while not typically synthesized use condensation polymerization, are also susceptible to hydrolytic degradation. Polyphenylene sulfide, polyphenylene oxide, poly ether ether ketone, poly ether ketone, poly ether ketone ketone, while not condensation polymers in the traditional sense, are highly susceptible to cross-linking and branching during melt processing and they are limited by thermal stability during processing and end use applications in the oil and gas Industries. All these polymers can be susceptible to UV degradation and thermal oxidative and hydrolytic degradation. It is reasonable to surmise that the current invention would have the same efficacy in preventing UV degradation, radical formation, chain scission and hydrolytic degradation.

The present invention could have usefulness in multiple applications. Areas area that are exposed to UV radiation in exterior and interior applications such as automotive exteriors, interior automotive skins, electrical and electronic devices, building and construction applications such as glazing, flooring, wall protection, and ceiling tiles, lighting applications such as LEDS and fluorescent lighting. Other applications include devices that emit UV radiation such as air cleaners, water disinfectors and lights such as UV emitting LEDS and fluorescent lights. The invention could also be incorporated into thermoplastics used in applications produced using 3D printing processes such as filament, extrusion and high-speed sintering and selective laser sintering of thermoplastic powders, articles coated with thermoplastic powders using conventional method of powder coating metal articles and plastic articles. The inventive compositions can be processed using multiple typical thermoplastic compound and processing techniques such as extrusion, injection molding, blow molding, calendaring and the like.

### EXAMPLES

The present invention includes and expressly contemplates any and all combinations of embodiments, features, characteristics, parameters, and/or ranges disclosed herein. That is, the invention may be defined by any combination of embodiments, features, characteristics, parameters, and/or ranges mentioned herein.

This invention can be further illustrated by the following examples of preferred embodiments thereof, although it will be understood that these examples are included merely for purposes of illustration and are not intended to limit the scope of the invention unless otherwise specifically indicated.

In all examples, the formulations studied can be found in Table 1 below. The samples in Table 1 were made by combining the following copolyesters:

Copolyester 1—Ecdel 9966

Copolyester 2—Poly(cyclohexylene dimethylene cyclohexanedicarboxylate), glycol and acid comonomer, with 17 mole percent polytetramethylene ether glycol having a number average molecular weight of about 1000 (PTMG 1000), and 0.5 mole percent trimellitic anhydride (TMA).

Copolyester 3—Poly(cyclohexylene dimethylene cyclohexanedicarboxylate), glycol and acid comonomer, and 17 mole percent polytetramethylene ether glycol having a number average molecular weight of about 1000 (PTMG 1000).

Copolyesters 1, 2 and 3 were combined with additives on a 26 mm Coperion twin screw compounding extruder to make pellets. Screw RPM was set at 200, Zone 1 was set at 180 C, zones 2 to 11 were set at 250 C, the die was set at 250 C. Extrudate exited a two hole die into a water bath to be cooled then into a pelletizer. These pellets were then injection molded into 4″×4″×0.125″ plaques on a BOY 22, BOY Machines, Inc. injection molding machine. Barrel temperature was set at 240 C, mold at 70 C, injection pressure was set at 80 bar, cooling was set for 25 seconds, and ejection force was set at 125 bar

Ecdel 9966 is a commercially available aliphatic copolyester made by Eastman Chemical Company with a glass transition temperature of about 50° C. and a melting point of around 204° C. Copolyesters 1 and 2 are experimental copolyester ether compositions, Cyasorb 1164 is a triazine-type UV absorber available from Solvay, Cyasorb 3529 is hindered amine light stabilizer available from Solvay, Irganox 1010 is a hindered phenolic primary anti-oxidant available from BASF, Irgafos 168 is a phosphite secondary anti-oxidant available from BASF and Joncryl 4468 is a multi-functional epoxide chain extender available from BASF.

### Xenon Arc Accelerated Weathering Methods

Two weathering methods were used to study accelerated weathering for interior and exterior automotive applications: SAE J2527 and SAE J2412.

### SAE J2527

SAE J2527 (also known as ASTM G155, Cycle 7A) Automotive Exterior Simulation, was run on an Atlas Ci5000 Xenon Arc weatherometer with the samples in a vertical orientation, Borosilicate inner and outer filters were used, with a control irradiance of 0.55@340 W/m2-nm, with radiant exposure units reported in hours, with a program cycle of 40 min light, 70° C. BPT, 47° C. CT, 50% RH followed by 20 min light w/front spray (BPT & CT & RH are not specified and are all machine dependent, but were set at J2527 conditions 70C, 47C, 50% RH respectively followed by 60 min light, 70° C. BPT, 47° C. CT, 50% RH, followed by 60 min dark with front & back spray, 38° C. BPT, 38° C. CT, 95% RH.

### SAE 2412

SAE J2527 (also known as ASTM G155, Cycle 8) Automotive Interior Simulation, was run on an Atlas Ci5000 Xenon Arc weatherometer with the samples in a vertical orientation, Borosilicate (Quartz SAE J2412) inner filter, Borosilicate Window B/SL exterior filter, with a control irradiance of 0.55@340 W/m2-nm, with radiant exposure units reported in hours, with a program cycle of 3.8 hours light, 89° C. Black Panel Temperature, Chamber Temperature controlled at (62° C. J2412), 50% Relative Humidity, followed by 1 hour dark, 38° C. Black Panel Temperature, Chamber Temperature controlled at (38° C. J2412), 95% Relative Humidity.

### Physical Property Testing

Samples were removed periodically and tested for color difference (ASTM D2244), gloss (ASTM D2457), and flatwise impact strength (FWIS) (ASTM D6395) for the samples in Table 1. The following tables summarize experimental results of the invention:

TABLE 1
Formulations

| | Formulation | | | | | | | | |
|---|---|---|---|---|---|---|---|---|---|
| | 1 | 2 | 3 | 4 | 5 | 6 | 7 | 8 | 9 |
| Copolyester 1 | 100 | 97.5 | 97.25 | 97.25 | 97 | 96.75 | 96.5 | | |
| Copolyester 2 | | | | | | | | 96.5 | |
| Copolyester 3 | | | | | | | | | 96.5 |
| Cyasorb 1164 | 0 | 0.25 | 0.25 | 0.5 | 0.5 | 1 | 1 | 1 | 1 |
| Cyasorb 3529 | 0 | 0.25 | 0.5 | 0.25 | 0.5 | 0.25 | 0.5 | 0.5 | 0.5 |
| Irganox 1010 | 0 | 1 | 1 | 1 | 1 | 1 | 1 | 1 | 1 |
| Irgafos 168 | 0 | 0.5 | 0.5 | 0.5 | 0.5 | 0.5 | 0.5 | 0.5 | 0.5 |
| Joncryl 4468 | 0 | 0.5 | 0.5 | 0.5 | 0.5 | 0.5 | 0.5 | 0.5 | 0.5 |

### Example 1

### Change in b*

Table 2 shows results for b* color change (yellowness/blueness) as measured by ASTM D2244 for formulations with UV absorber, primary and secondary anti-oxidants, HALS and chain extender. Formulations 1 and 9 show a rapid decrease in b* while formulations 2 to 7 show a gradual increase in b*. The decrease in b* for formulations 1 and 9 are indicative of a bleaching effect from the light source in the Xenon Arc causing the samples to go slightly bluer. Formulations 1 through 7 used Copolyester 1 as the base resin which was manufactured on commercial scale assets. Copolyester 3 was made in a batch pilot plant so therefore has more unreacted components which make the initial color quite yellow. By comparing formulations 1 through 7 it is plainly seen that the incorporation of the stabilizing additives greatly decreases the amount of yellowing. By comparing formulations 1 and 9 is it plainly seen that once Copolyester 3 initially bleaches, it has excellent resistance to yellowing.

TABLE 2
Automotive Exterior Simulation

| | Delta b* | | | | | | | | |
|---|---|---|---|---|---|---|---|---|---|
| Hours | 1 | 2 | 3 | 4 | 5 | 6 | 7 | 8 | 9 |
| 0 | 0.0 | 0.0 | 0.0 | 0.0 | 0.0 | 0.0 | 0.0 | | 0.0 |
| 600 | | | | | | | | | −9.1 |
| 647 | −8.8 | 0.6 | −0.2 | −0.2 | −0.8 | −0.4 | −1.2 | | −9.8 |
| 1200 | −11.0 | 1.7 | 0.7 | 1.0 | −0.1 | 1.0 | −0.4 | | |
| 1738 | | | | | | | | | −9.9 |
| 1800 | −12.4 | 2.5 | 1.1 | 2.4 | 0.5 | 1.9 | 0.1 | | −9.8 |
| 2050 | −13.8 | 5.9 | 4.7 | 5.4 | 4.5 | 5.1 | 3.9 | | |
| 2976 | | | | | | | | | −9.5 |
| 3847 | −14.2 | 6.6 | 5.5 | 6.1 | 5.3 | 5.6 | 4.8 | | |
| 5047 | | 7.6 | 7.6 | 7.1 | 7.6 | 6.7 | 7.2 | | −9.3 |

### Example 2

Total Color Change—d(E)

Table 3 shows results for total color change as measured by ASTM D2244 for formulations with UV absorber, primary and secondary anti-oxidants, HALS and chain extender. Formulations 1 and 9 show a rapid total color change while formulations 2 to 7 show a gradual increase in total color change. Formulations 1 through 7 used Copolyester 1 as the base resin which was manufactured on commercial scale assets Copolyester 3 was made in a batch pilot plant so therefore has more unreacted components which make the initial color quite yellow. By comparing formulations 1 through 7 it is plainly seen that the incorporation of the stabilizing additives greatly decreases the rate of color change. By comparing formulations 1 and 9 is it plainly seen that once Copolyester 3 initially bleaches, it has excellent resistance to color change.

TABLE 3
Delta E Copolyester 1 and Copolyester
3 Automotive Exterior Simulation

| | Delta E | | | | | | | | |
|---|---|---|---|---|---|---|---|---|---|
| Hours | 1 | 2 | 3 | 4 | 5 | 6 | 7 | 8 | 9 |
| 0 | 0 | 0 | 0 | 0 | 0 | 0 | 0 | | 0 |
| 647 | 10.8 | 1 | 0.8 | 0.8 | 1.2 | 1.4 | 1.6 | | 9.7 |
| 1200 | 13.8 | 2 | 1.2 | 1.5 | 1.1 | 1.8 | 1.3 | | 10.4 |
| 1800 | 15.6 | 2.7 | 1.5 | 2.6 | 1.2 | 2.2 | 1 | | 10.5 |
| 2050 | 19.3 | 6.1 | 4.9 | 5.6 | 4.6 | 5.2 | 4.1 | | 10.1 |
| 3847 | 19.9 | 6.7 | 5.7 | 6.2 | 5.4 | 5.6 | 4.9 | | 9.7 |
| 5047 | | 7.7 | 7.7 | 7.2 | 7.8 | 6.7 | 7.2 | | 9.5 |

### Example 3

### Flatwise Impact Strength

Table 4 shows flatwise impact strength values as measured by ASTM D6395 for formulations with UV absorber, primary and secondary anti-oxidants, HALS and Nor-HALs and chain extender. The data shows that formulation 1 rapidly decreases in impact strength while formulations 2 to 7 and 9 all maintain early high impact strength and only gradually decrease with prolonged exposure. This indicates that the stabilizing additives are protecting the polymer from attack by UV, humidity and Heat.

TABLE 4
Flatwise Impact Strength Copolyester 1 and Copolyester
3 Automotive Exterior Simulation

| | Flatwise Impact Strength (kJ/m2) | | | | | | | | |
|---|---|---|---|---|---|---|---|---|---|
| Hours | 1 | 2 | 3 | 4 | 5 | 6 | 7 | 8 | 9 |
| 0 | 25.5 | 24.3 | 23.5 | 24.8 | 23.9 | 23.2 | 23.9 | | 5.4 |
| 600 | | | | | | | | | 5.5 |
| 647 | 4.0 | 15.8 | 16.3 | 15.5 | 16.2 | 15.9 | 15.4 | | |
| 1200 | 3.0 | 14.6 | 15.2 | 15.2 | 14.1 | 12.5 | 13.9 | | |
| 1738 | | | | | | | | | 6.5 |
| 1800 | 3.2 | 16.3 | 15.1 | 15.4 | 15.5 | 14.5 | 15.3 | | |
| 2383 | | | | | | | | | 6.0 |
| 2976 | | | | | | | | | 5.2 |
| 3847 | 0.6 | 5.4 | 2.1 | 4.7 | 3.1 | 9.2 | 2.4 | | |
| 4519 | 0.1 | 4.1 | 4.5 | 12.2 | 6.9 | 13.3 | 12.8 | | |

Table 5 shows the ductile impact retention as measured by ASTM D6395 for formulations with UV absorber, primary and secondary anti-oxidants, HALS and Nor-HALs and chain extender. The data shows that formulation 1 gradually loses ductility until it is completely brittle while formulations 2 to 7 and 9 all maintain either 100 percent ductility or a high level of ductility. This indicates that the stabilizing additives are protecting the polymer from attack by UV, humidity and Heat.

TABLE 5
Flatwise Impact Strength - Ductility Copolyester 1
and Copolyester 3 Automotive Exterior Simulation

| | Flatwise Impact Strength - Percent Ductile | | | | | | | | |
|---|---|---|---|---|---|---|---|---|---|
| Hours | 1 | 2 | 3 | 4 | 5 | 6 | 7 | 8 | 9 |
| 0 | 100.0 | 100.0 | 100.0 | 100.0 | 100.0 | 100.0 | 100.0 | | 100.0 |
| 600 | | | | | | | | | 100 |
| 647 | 75.0 | 100.0 | 100.0 | 100.0 | 100.0 | 100.0 | 100.0 | | |
| 1200 | 75.0 | 100.0 | 100.0 | 100.0 | 100.0 | 97.0 | 100.0 | | |
| 1738 | | | | | | | | | 100 |
| 1800 | 75.0 | 100.0 | 100.0 | 100.0 | 100.0 | 100.0 | 100.0 | | |
| 2383 | | | | | | | | | 100 |
| 2976 | | | | | | | | | 100 |
| 3847 | 0.0 | 81.0 | 75.0 | 72.0 | 69.0 | 88.0 | 75.0 | | |
| 4519 | 0.0 | 75.0 | 69.0 | 91.0 | 44.0 | 100.0 | 100.0 | | |

### Example 4

### 60 Degree Gloss

Table 6 shows 60-degree gloss values as measured by ASTM D2457 formulations with UV absorber, primary and secondary anti-oxidants, HALS and Nor-HALs and chain extender. The data shows that formulation 1 rapidly decreases in gloss indicating a massive degree of polymer degradation on the surface caused by UV, humidity and heat. Formulations 1 through 7 had varying degrees of initial low gloss which where an artifact of the sample preparation process. Once weathering commenced, high gloss levels were achieved and maintained over a long duration. Formulation 9 shows little decrease in gloss levels.

TABLE 6
60 Degree Gloss Copolyester 1 and Copolyester
3 Automotive Exterior Simulation

| | 60 Degree Gloss | | | | | | | | |
|---|---|---|---|---|---|---|---|---|---|
| Hours | 1 | 2 | 3 | 4 | 5 | 6 | 7 | 8 | 9 |
| 0 | 90.2 | 77.1 | 75.7 | 73.1 | 92.7 | 91.7 | 90.8 | | 89.5 |
| 600 | | | | | | | | | 90.6 |
| 647 | 24.3 | 92.3 | 92.4 | 92.1 | 93.1 | 92.7 | 92.7 | | |
| 1200 | 18.7 | 92.5 | 92.9 | 92.7 | 93.1 | 92.6 | 92.8 | | 92.7 |
| 1738 | | | | | | | | | 92.5 |
| 1800 | 11.3 | 92.5 | 93 | 92.7 | 92.8 | 93 | 93.4 | | |
| 2050 | 5.3 | 93.2 | 92.5 | 92.5 | 93.8 | 93.3 | 93.5 | | |
| 2976 | | | | | | | | | 92 |
| 3847 | 4.7 | 92.9 | 93.4 | 93.4 | 93.5 | 93.5 | 94 | | |
| 5047 | | 83.3 | 92.3 | 91.5 | 87.8 | 92.3 | 92.6 | | 92 |

### Automotive Interior Simulation SAE J2412

### Example 5

### Change in b*

Table 7 shows results for b* color change (yellowness/blueness) as measured by ASTM D2244 for formulations with UV absorber, primary and secondary anti-oxidants, HALS and chain extender. Formulation 1 rapidly decreased in b* and completely disintegrated at about 800 hours of exposure. Formulations 2 to 7 show a gradual increase in b*. Formulation 9 shows a rapid decrease in b*. This decrease in b* for formulation 9 is indicative of a bleaching effect from the light source in the Xenon Arc causing the samples to go slightly bluer. Formulations 1 through 7 used Copolyester 1 as the base resin which was manufactured on commercial scale assets. Copolyester 2 was made in a batch pilot plant so therefore has more unreacted components which make the initial color quite yellow. By comparing formulations 1 through 7 it is plainly seen that the incorporation of the stabilizing additives greatly decreases the amount of yellowing. By comparing formulations 1 and 9 is it plainly seen that once Copolyester 2 initially bleaches, it has excellent resistance to yellowing.

TABLE 7
Delta b* Copolyester 1 and Copolyester
2 Automotive Interior Simulation

| | Delta b* | | | | | | | | |
|---|---|---|---|---|---|---|---|---|---|
| Hours | 1 | 2 | 3 | 4 | 5 | 6 | 7 | 8 | 9 |
| 0 | 0.0 | 0.0 | 0.0 | 0.0 | 0.0 | 0.0 | 0.0 | 0.0 | |
| 128 | −6.9 | 0.8 | 0.3 | 0.0 | −0.3 | −0.6 | −0.9 | −8.0 | |
| 202 | | | | | | | | −8.1 | |
| 256 | −10.7 | 1.7 | 1.1 | 1.1 | 0.5 | 0.5 | −0.1 | | |
| 399 | | | | | | | | −8.3 | |
| 639 | −8.7 | 5.8 | 4.8 | 4.3 | 4.4 | 4.6 | 4.0 | | |
| 798 | Sample | | | | | | | −7.5 | |
| 1197 | Fell | | | | | | | −6.1 | |
| 1278 | Apart | 13.1 | 12.0 | 12.4 | 13.9 | 12.9 | 13.0 | | |
| 1437 | | | | | | | | −5.2 | |
| 1917 | | 17.4 | 20.6 | 16.2 | 21.0 | 15.7 | 19.6 | | |
| 2044 | | 19.3 | 21.6 | 18.2 | 21.1 | 16.9 | 19.3 | | |
| 2437 | | | | | | | | −3.3 | |

### Example 6

Total Color Change—d(E)

Table 8 shows results for total color change as measured by ASTM D2244 for formulations with UV absorber, primary and secondary anti-oxidants, HALS and chain extender. Formulations 1 and 8 show a rapid total color change while formulations 2 to 7 show a gradual increase in total color change. Formulation 1 completely disintegrated at about 800 hours of exposure. Formulations 1 through 7 used Copolyester 1 as the base resin which was manufactured on commercial scale assets. Copolyester 2 was made in a batch pilot plant so therefore has more unreacted components which make the initial color quite yellow. By comparing formulations 1 through 7 it is plainly seen that the incorporation of the stabilizing additives greatly decreases the rate of color change. By comparing formulations 1 and 8 is it plainly seen that once Copolyester 2 initially bleaches, it has excellent resistance to color change.

TABLE 8
Delta E Copolyester 1 and Copolyester
2 Automotive Interior Simulation

| | Delta E | | | | | | | | |
|---|---|---|---|---|---|---|---|---|---|
| Hours | 1 | 2 | 3 | 4 | 5 | 6 | 7 | 8 | 9 |
| 0 | 0.0 | 0.0 | 0.0 | 0.0 | 0.0 | 0.0 | 0.0 | 0.0 | |
| 128 | 8.0 | 1.0 | 0.7 | 0.6 | 0.8 | 1.0 | 1.1 | 8.6 | |
| 202 | | | | | | | | 8.8 | |
| 256 | 12.8 | 1.9 | 1.3 | 1.3 | 1.0 | 1.1 | 0.8 | | |
| 399 | | | | | | | | 8.9 | |
| 639 | 13.7 | 5.9 | 4.9 | 4.4 | 4.5 | 4.6 | 4.0 | | |
| 798 | Sample | | | | | | | 8.8 | |
| 1197 | Fell | | | | | | | 6.5 | |
| 1278 | Apart | 13.2 | 12.1 | 12.6 | 14.2 | 13.1 | 13.4 | | |
| 1437 | | | | | | | | 5.7 | |
| 1917 | | 17.6 | 21.4 | 16.5 | 21.8 | 16.1 | 20.7 | | |
| 2044 | | 19.6 | 22.4 | 18.6 | 21.9 | 17.3 | 20.3 | | |
| 2437 | | | | | | | | 4.1 | |

### Example 7

### Flatwise Impact Strength

Table 9 shows flatwise impact strength values as measured by ASTM D6395 for formulations with UV absorber, primary and secondary anti-oxidants, HALS and Nor-HALs and chain extender. The data shows that formulation 1 rapidly decreases in impact strength while formulations 2 to 7 and 8 all maintain early high impact strength and only gradually decrease with prolonged exposure. Formulation 1 completely disintegrated at about 800 hours of exposure. This indicates that the stabilizing additives are protecting the polymer from attack by UV, humidity and Heat.

Table 10 shows the ductile impact retention as measured by ASTM D6395 for formulations with UV absorber, primary and secondary anti-oxidants, HALS and Nor-HALs and chain extender. The data shows that formulation 1 maintains early ductility but once it disintegrates it is untestable. Formulations 2 to 7 and 8 all maintain either 100 percent ductility or a high level of ductility even though the absolute value of impact strength decreases. This indicates that the stabilizing additives are protecting the polymer from attack by UV, humidity and Heat.

TABLE 9
Flatwise Impact Strength Copolyester 1 and Copolyester
2 Automotive Interior Simulation

| | Flatwise Impact Strength (kJ/m2) | | | | | | | | |
|---|---|---|---|---|---|---|---|---|---|
| Hours | 1 | 2 | 3 | 4 | 5 | 6 | 7 | 8 | 9 |
| 0 | 25.5 | 24.3 | 23.5 | 24.8 | 23.9 | 23.2 | 23.9 | 5.6 | |
| 128 | 12.1 | 21.9 | 19.9 | 20.8 | 25.1 | 21.9 | 21.4 | | |
| 200 | | | | | | | | 11.6 | |
| 256 | 14.2 | 20.3 | 21.1 | 22.1 | 20.7 | 23.6 | 19.5 | | |
| 639 | Sample | | 7.7 | | | | 3.9 | | |
| 798 | Fell | | | | | | | 9.6 | |
| 1197 | Apart | | | | | | | 6.2 | |
| 1278 | | 4.7 | 2.8 | 5.7 | 5.3 | 6.1 | 18.3 | | |
| 1738 | | | | | | | | | |
| 1917 | | 3.2 | 4.0 | 2.9 | 2.0 | 5.1 | 3.2 | | |
| 2301 | | 1.8 | 1.4 | 1.5 | 1.2 | 1.6 | 1.2 | | |
| 3951 | | | | | | | | 5.8 | |
| 4346 | | | | | | | | 6 | |

TABLE 10
Flatwise Impact Strength - Ductility Copolyester 1
and Copolyester 2 Automotive Interior Simulation

| | Flatwise Impact Strength - Percent Ductile | | | | | | | | |
|---|---|---|---|---|---|---|---|---|---|
| Hours | 1 | 2 | 3 | 4 | 5 | 6 | 7 | 8 | 9 |
| 0 | 100.0 | 100.0 | 100.0 | 100.0 | 100.0 | 100.0 | 100.0 | 100.0 | |
| 128 | 100.0 | 100.0 | 100.0 | 100.0 | 100.0 | 100.0 | 100.0 | | |
| 200 | | | | | | | | 100.0 | |
| 256 | 100 | 100.0 | 100.0 | 100.0 | 100.0 | 100.0 | 100.0 | | |
| 639 | Sample | | 81.0 | | | | 75.0 | | |
| 798 | Fell | | | | | | | 100 | |
| 1197 | Apart | | | | | | | 100 | |
| 1278 | | 75.0 | 75.0 | 81.0 | 78.0 | 81.0 | 100.0 | | |
| 1738 | | | | | | | | | |
| 1917 | | 75.0 | 75.0 | 75.0 | 75.0 | 53.0 | 75.0 | | |
| 2301 | | 75.0 | 47.0 | 75.0 | 75.0 | 75.0 | 75.0 | | |
| 3951 | | | | | | | | 100 | |
| 4346 | | | | | | | | 100 | |

### Example 8

### 60 Degree Gloss

Table 11 shows 60-degree gloss values as measured by ASTM D2457 formulations with UV absorber, primary and secondary anti-oxidants, HALS and Nor-HALs and chain extender. The data shows that formulation 1 rapidly decreases in gloss indicating a massive degree of polymer degradation on the surface caused by UV, humidity and heat. Formulations 1 through 7 had varying degrees of initial low gloss which where an artifact of the sample preparation process. Once weathering commenced, high gloss levels were achieved and maintained over a long duration. Formulation 8 shows little decrease in gloss levels.

TABLE 11
60 Degree Gloss Copolyester 1 and Copolyester
2 Automotive Interior Simulation

| | 60 Degree Gloss | | | | | | | | |
|---|---|---|---|---|---|---|---|---|---|
| Hours | 1 | 2 | 3 | 4 | 5 | 6 | 7 | 8 | 9 |
| 0 | 90.2 | 85.1 | 71.4 | 78.9 | 61.5 | 91.8 | 65.4 | 90.0 | |
| 128 | 17.0 | 89.2 | 90.0 | 90.7 | 90.2 | 91.0 | 88.4 | 89.4 | |
| 202 | | | | | | | | 79.2 | |
| 256 | 11.4 | 88.9 | 89.6 | 89.3 | 89.3 | 89.9 | 88.8 | | |
| 399 | | | | | | | | 59.4 | |
| 639 | 4.1 | 87.7 | 89.1 | 85.0 | 89.0 | 89.2 | 88.9 | | |
| 798 | | | | | | | | 24.5 | |
| 1197 | | | | | | | | 74.8 | |
| 1278 | | 86.1 | 89.8 | 89.8 | 89.6 | 90.4 | 89.9 | | |
| 1437 | | | | | | | | 64.5 | |
| 1917 | | 65.3 | 62.4 | 71.2 | 76.8 | 86.5 | 89.1 | | |
| 2044 | | 47.5 | 47.6 | 54.1 | 62.7 | 72.8 | 77.7 | | |
| 2437 | | | | | | | | 30.8 | |

In the specification, there have been disclosed certain embodiments of the invention and, although specific terms are employed, they are used in a generic and descriptive sense only and not for purposes of limitation, the scope of the invention being set forth in the following claims.

We claim:

1. An ultraviolet light degradation resistant composition comprising:
a. a polymer;
b. at least one UV absorber;
c. at least one primary antioxidant;
d. at least one secondary antioxidant;
e. at least one hindered amine light stabilizer; and
f. at least one chain extending agent.

2. The composition of claim 1 wherein said polymer is selected from the group consisting of polyesters, copolyesters, liquid crystalline polyesters/amides/imides, polyesteramides, polyimides, polyetherimides, polyurethanes, polyureas, polybenzimidazole, polybenzoxazoles, polyimines, polycarbonate, and polyamides

3. The composition of claim 1 wherein said polymer is selected from the group consisting of polycaprolactone, polycaprolactam, polyphenylene sulfide, polyphenylene oxide, poly ether ether ketone, poly ether ketone, poly ether ketone ketone.

4. The composition of claim 1 wherein said UV absorber B is selected from the group consisting of benzotriazoles, benzophenones, triazines, benzoxazinones, oxanilides and benzylidene malonates and combinations thereof.

5. The composition of claim 1 wherein said primary antioxidant is selected from the group consisting of hindered phenols and arylamines.

6. The composition of claim 1 wherein said primary antioxidant is selected from the group consisting of hydroquinone; 4,4′-bis(α,α-dimethylbenzyl)diphenylamine; 2,6-di-tert-butyl-4-methylphenol; butylated p-phenyl-phenol; phenyl-phenol; 2-(a-methylcyclohexyl)-4,6-dimethylphenol; 2,2′-methylenebis-(6-tert-butyl-4-methylphenol); 4,4′bis(2,6-di-tert-butylphenol), 4,4′-methylenebis(6-tert-butyl-2-methylphenol); 4,4′-butylene-bis(6-tert-butyl-3-methylphenol); methylenebis(2,6di-tertbutylphenol; 4,4′-thiobis(6-tert-butyl-2-methylphenol); 2,2′-thiobis(4-methyl-6-tert-butylphenol); 1,3,5-tris(3,5-di-tert-butyl-4-hydroxyhydrocinnamoyl)-hexahydro-s-triazine; 1,3,5-trimethyl-2,4,6-tris(3,5-di-tert-butyl-4-hydroxybenzyl)benzene; tri(3,5-di-tert-butyl-4-hydroxyphenyl)phosphite; pentaerythritol tetrakis[3-(3,5-di-t-butyl-4-hydroxyphenyl)propionate] and combinations thereof.

7. The composition of claim 1 wherein said secondary antioxidant is selected from the group consisting of phosphites or phosphonites.

8. The composition of claim 1 wherein said secondary antioxidant is selected from the group consisting of tris(nonyl phenyl)phosphite; tris(2,4-di-t-butylphenyl)phosphite; bis(2,4-di-t-butylphenyl)pentaerythritol diphosphate; distearyl pentaerythritol diphosphite and combinations thereof.

9. The composition of claim 1 wherein said hindered amine light stabilizer is selected from the group consisting of 1,6-hexanediamine N, N′-bis(2,2,6,6-tetramethyl-4-piperidinyl); morpholine-2,4,6-trichloro1,3,5-triazine containing polymers, or combinations thereof.

10. The composition of claim 1 wherein said chain extending agent is selected from the group consisting of bisanhydrides, bisoxaolines, bisepoxides and styrene-acrylate copolymers.

11. The composition of claim 1 wherein said chain extending agent is selected from the group consisting of copolymers of glycidyl methacrylate with alkenes and acrylic esters; copolymers of glycidyl methacrylate with alkenes and vinyl acetate; copolymers of glycidyl methacrylate and styrene and combinations thereof.

12. The composition of claim 11 wherein said alkenes are ethylene, propylene, and combinations thereof.

13. The composition of claim 11 wherein said acrylic esters are selected from the group consisting of methyl acrylate, ethyl acrylate, propyl acrylate, butyl acrylate, and combinations thereof.

14. The composition of claim 1 wherein said chain extender is selected from the group consisting of ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, ethylene-glycidyl methacrylate-butyl acrylate copolymers and combinations thereof.

15. An ultraviolet light degradation resistant composition comprising:
a. a polyester;
b. at least one triazine UV absorber;
c. at least one hindered phenol primary antioxidant;
d. at least one phosphite secondary antioxidant;
e. at least one hindered amine light stabilizer; and
f. at least one styrene-acrylate copolymer.

16. The composition of claim 15 wherein said polyester comprises the residues of:
i. at least one of cyclohexane 1,4 dicarboxylic acid or dimethyl cyclohexane dicarboxylate; and
ii. at least one of 1, 4 cyclohexanedimethanol or polytetramethylene ether glycol.

17. An ultraviolet light degradation resistant composition comprising:
a. 0.1 to 3% by weight of at least one triazine UV absorber;
b. 0.1 to 2% by weight of at least one hindered phenol primary antioxidant;
c. 01 to 0.5% by weight of at least one phosphite secondary antioxidant;
d. 0.1 to 2% by weight of at least one hindered amine light stabilizer;
e. 0.01 to 2.0% by weight of at least one styrene-acrylate copolymer; and
f. the balance to 100 weight percent of a polyester.
